(19) United States
(12) Patent Application Publication
(10) Pub. No.: US 2015/0014606 A1
(43) Pub. Date: Jan. 15, 2015

(54) AZEOTROPE-LIKE COMPOSITIONS OF Z-1,1,1,4,4,4-HEXAFLUORO-2-BUTENE AND E-1,1,1,4,4,4-HEXAFLUORO-2-BUTENE AND USES THEREOF

(71) Applicant: E I DU PONT DE NEMOURS AND COMPANY, Wilmington, DE (US)

(72) Inventors: Mark L. Robin, Middletown, DE (US); Joseph Anthony Creazzo, Wilmington, DE (US); Gary Loh, Newark, DE (US)

(21) Appl. No.: 14/378,342

(22) PCT Filed: Feb. 14, 2013
(86) PCT No.: PCT/US2013/026133

§ 371 Date: Aug. 13, 2014

Related U.S. Application Data
(60) Provisional application No. 61/599,993, filed on Feb. 17, 2012.

(51) Int. Cl. C08J 9/14; C09K 5/00; C09K 5/04; A62D 1/00; H01B 3/56; F25B 39/02; C09K 3/30; C08G 18/71; C08G 18/32; C08G 18/34; C08G 18/08; C09K 3/00; B01F 17/00

(52) U.S. Cl. CPC C08J 9/146; C09K 3/00; C09K 5/00; C09K 5/045; A62D 1/00; H01B 3/56; B01F 17/0035; C09K 3/30; C08G 18/71; C08G 18/3203; C08G 18/348; C08G 18/14; F25B 39/02; C08J 2375/08
USPC 252/571; 252/364; 252/78.1; 516/12; 521/131; 516/8; 521/170; 62/119; 169/46

(57) ABSTRACT

Azeotrope-like compositions are disclosed. The azeotrope-like compositions are mixtures of Z-1,1,1,4,4,4-hexafluoro-2-butene and E-1,1,1,4,4,4-hexafluoro-2-butene. Also disclosed is a process of preparing a thermoplastic or thermoset foam by using such azeotrope-like compositions as blowing agents. Also disclosed is a process of producing refrigeration by using such azeotrope-like compositions. Also disclosed is a process of using such azeotrope-like compositions as solvents. Also disclosed is a process of producing an aerosol product by using such azeotrope-like compositions. Also disclosed is a process of using such azeotrope-like compositions as heat transfer media. Also disclosed is a process of extinguishing or suppressing a fire by using such azeotrope-like compositions. Also disclosed is a process of using such azeotrope-like compositions as dielectrics. Also disclosed is a foam-forming composition containing such azeotrope-like composition and an active hydrogen-containing compound having two or more active hydrogens.

### BACKGROUND OF THE INVENTION

1. Field of the Disclosure

The present disclosure relates to azeotrope-like compositions of Z-1,1,1,4,4,4-hexafluoro-2-butene and E-1,1,1,4,4,4-hexafluoro-2-butene.

2. Description of Related Art

Many industries have been working for the past few decades to find replacements for the ozone depleting chlorofluorocarbons (CFCs) and hydrochlorofluorocarbons (HCFCs). The CFCs and HCFCs have been employed in a wide range of applications, including their use as aerosol propellants, refrigerants, cleaning agents, expansion agents for thermoplastic and thermoset foams, heat transfer media, gaseous dielectrics, fire extinguishing and suppression agents, power cycle working fluids, polymerization media, particulate removal fluids, carrier fluids, buffing abrasive agents, and displacement drying agents. In the search for replacements for these versatile compounds, many industries have turned to the use of hydrofluorocarbons (HFCs).

The HFCs do not contribute to the destruction of stratospheric ozone, but are of concern due to their contribution to the “greenhouse effect”, i.e., they contribute to global warming. As a result of their contribution to global warming, the HFCs have come under scrutiny, and their widespread use may also be limited in the future. Thus, there is a need for compositions that do not contribute to the destruction of stratospheric ozone and also have low global warming potentials (GWPs). Certain hydrofluoroolefins, such as 1,1,1,4,4,4-hexafluoro-2-butene (CF₃CH═CHCF₃, FC-1336mzz, HFO-1336mzz), are believed to meet both goals.

Closed-cell polyisocyanate-based foams are widely used for insulation purposes, for example, in building construction and in the manufacture of energy efficient electrical appliances. In the construction industry, polyurethane/polyisocyanurate board stock is used in roofing and siding for its insulation and load-carrying capabilities. Poured and sprayed polyurethane foams are widely used for a variety of applications including insulating roofs, insulating large structures such as storage tanks, insulating appliances such as refrigerators and freezers, insulating refrigerated trucks and railcars, etc.

All of these various types of polyurethane/polyisocyanurate foams require blowing agents for their manufacture. Insulating foams depend on the use of halocarbon blowing agents, not only to foam the polymer, but primarily for their low vapor thermal conductivity, a very important characteristic for insulation value.

### SUMMARY OF THE INVENTION

This disclosure provides a composition consisting essentially of (a) Z-HFO-1336mzz and (b) E-HFO-1336mzz; wherein the E-HFO-1336mzz is present in an effective amount to form an azeotrope-like mixture with Z-HFO-1336mzz.

### BRIEF SUMMARY OF THE DRAWINGS

FIG. 1—FIG. 1 is a graphical representation of an azeotrope-like composition of Z-HFO-1336mzz and E-HFO-1336mzz at a temperature of about 20.0° C.

### DETAILED DESCRIPTION OF THE INVENTION

In many applications, the use of a pure single component or an azeotropic or azeotrope-like mixture is desirable. For example, when a blowing agent composition (also known as foam expansion agents or foam expansion compositions) is not a pure single component or an azeotropic or azeotrope-like mixture, the composition may change during its application in the foam forming process. Such change in composition could detrimentally affect processing or cause poor performance in the application. Also, in refrigeration applications, a refrigerant is often lost during operation through leaks in shaft seals, hose connections, soldered joints and broken lines. In addition, the refrigerant may be released to the atmosphere during maintenance procedures on refrigeration equipment. If the refrigerant is not a pure single component or an azeotropic or azeotrope-like composition, the refrigerant composition may change when leaked or discharged to the atmosphere from the refrigeration equipment. The change in refrigerant composition may cause the refrigerant to become flammable or to have poor refrigeration performance. Accordingly, there is a need for using azeotropic or azeotrope-like mixtures in these and other applications, for example azeotropic or azeotrope-like mixtures containing Z-1,1,1,4,4,4-hexafluoro-2-butene (Z-CF₃OH═CHCF₃, Z-FC-1336mzz, Z-HFO-1336mzz) and E-1,1,1,4,4,4-hexafluoro-2-butene (E-CF₃CH═CHCF₃, E-FC-1336mzz, E-HFO-1336mzz).

Before addressing details of embodiments described below, some terms are defined or clarified.

HFO-1336mzz may exist as one of two configurational isomers, E or Z. HFO-1336mzz as used herein refers to the isomers, Z-HFO-1336mzz or E-HFO-1336mzz, as well as any combinations or mixtures of such isomers.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

Z-HFO-1336mzz is a known compound, and can be made by the selective hydrogenation of hexafluoro-2-butyne with a Lindlar catalyst and hydrogen, such as disclosed in U.S. Patent Publication No. 2008-0269532.

E-HFO-1336mzz is also a known compound, and can be made through the reaction of 1,2-dichloro-1,1,4,4,4-pentafluorobutane with dried KF in distilled tetramethylene sulphone, such as disclosed in U.S. Pat. No. 5,463,150.

### Azeotrope-like Compositions of Z-HFO-1336mzz and E-HFO-1336mzz

This application includes compositions consisting essentially of (a) Z-HFO-1336mzz and (b) E-HFO-1336mzz; wherein the E-HFO-1336mzz is present in an effective amount to form an azeotrope-like mixture with Z-HFO-1336mzz.

By effective amount is meant an amount of E-HFO-1336mzz, which, when combined with Z-HFO-1336mzz, results in the formation of an azeotrope-like mixture. This definition includes the amounts of each component, which amounts may vary depending on the pressure applied to the composition so long as the azeotrope-like compositions continue to exist at the different pressures, but with possible different boiling points. Therefore, effective amount includes the amounts, such as may be expressed in weight or mole percentages, of each component of the compositions of the instant invention which form azeotrope-like compositions at temperatures or pressures other than as described herein.

As recognized in the art, an azeotropic composition is an admixture of two or more different components which, when in liquid form under a given pressure, will boil at a substantially constant temperature, which temperature may be higher or lower than the boiling temperatures of the individual components, and which will provide a vapor composition essentially identical to the overall liquid composition undergoing boiling. (see, e.g., M. F. Doherty and M. F. Malone, Conceptual Design of Distillation Systems, McGraw-Hill (New York), 2001, 185-186, 351-359).

Accordingly, the essential features of an azeotropic composition are that at a given pressure, the boiling point of the liquid composition is fixed and that the composition of the vapor above the boiling composition is essentially that of the overall boiling liquid composition (i.e., no fractionation of the components of the liquid composition takes place). It is also recognized in the art that both the boiling point and the weight percentages of each component of the azeotropic composition may change when the azeotropic composition is subjected to boiling at different pressures. Thus, an azeotropic composition may be defined in terms of the unique relationship that exists among the components or in terms of the compositional ranges of the components or in terms of exact weight percentages of each component of the composition characterized by a fixed boiling point at a specified pressure.

For the purpose of this invention, an azeotrope-like composition means a composition that behaves like an azeotropic composition (i.e., has constant boiling characteristics or a tendency not to fractionate upon boiling or evaporation). Hence, during boiling or evaporation, the vapor and liquid compositions, if they change at all, change only to a minimal or negligible extent. This is to be contrasted with non-azeotrope-like compositions in which during boiling or evaporation, the vapor and liquid compositions change to a substantial degree.

Additionally, azeotrope-like compositions exhibit dew point pressure and bubble point pressure with virtually no pressure differential. That is to say that the difference in the dew point pressure and bubble point pressure at a given temperature will be a small value. In this invention, compositions with a difference in dew point pressure and bubble point pressure of less than or equal to 5 percent (based upon the bubble point pressure) is considered to be azeotrope-like.

It is recognized in this field that when the relative volatility of a system approaches 1.0, the system is defined as forming an azeotropic or azeotrope-like composition. Relative volatility is the ratio of the volatility of component 1 to the volatility of component 2. The ratio of the mole fraction of a component in vapor to that in liquid is the volatility of the component.

To determine the relative volatility of any two compounds, a method known as the PTx method can be used. The vapor-liquid equilibrium (VLE), and hence relative volatility, can be determined either isothermally or isobarically. The isothermal method requires measurement of the total pressure of mixtures of known composition at constant temperature. In this procedure, the total absolute pressure in a cell of known volume is measured at a constant temperature for various compositions of the two compounds. The isobaric method requires measurement of the temperature of mixtures of known composition at constant pressure. In this procedure, the temperature in a cell of known volume is measured at a constant pressure for various compositions of the two compounds. Use of the PTx Method is described in detail in “Phase Equilibrium in Process Design”, Wiley-Interscience Publisher, 1970, written by Harold R. Null, on pages 124 to 126.

These measurements can be converted into equilibrium vapor and liquid compositions in the PTx cell by using an activity coefficient equation model, such as the Non-Random, Two-Liquid (NRTL) equation, to represent liquid phase nonidealities. Use of an activity coefficient equation, such as the NRTL equation is described in detail in “The Properties of Gases and Liquids,” 4th edition, published by McGraw Hill, written by Reid, Prausnitz and Poling, on pages 241 to 387, and in “Phase Equilibria in Chemical Engineering,” published by Butterworth Publishers, 1985, written by Stanley M. Walas, pages 165 to 244. Without wishing to be bound by any theory or explanation, it is believed that the NRTL equation, together with the PTx cell data, can sufficiently predict the relative volatilities of the Z-HFO-1336mzz/E-HFO-1336mzz compositions of the present invention and can therefore predict the behavior of these mixtures in multi-stage separation equipment such as distillation columns.

It was found through experiments that Z-HFO-1336mzz and E-HFO-1336mzz form azeotrope-like compositions.

To determine the relative volatility of this binary pair, the PTx method described above was used. The pressure in a PTx cell of known volume was measured at constant temperature for various binary compositions. These measurements were then reduced to equilibrium vapor and liquid compositions in the cell using the NRTL equation.

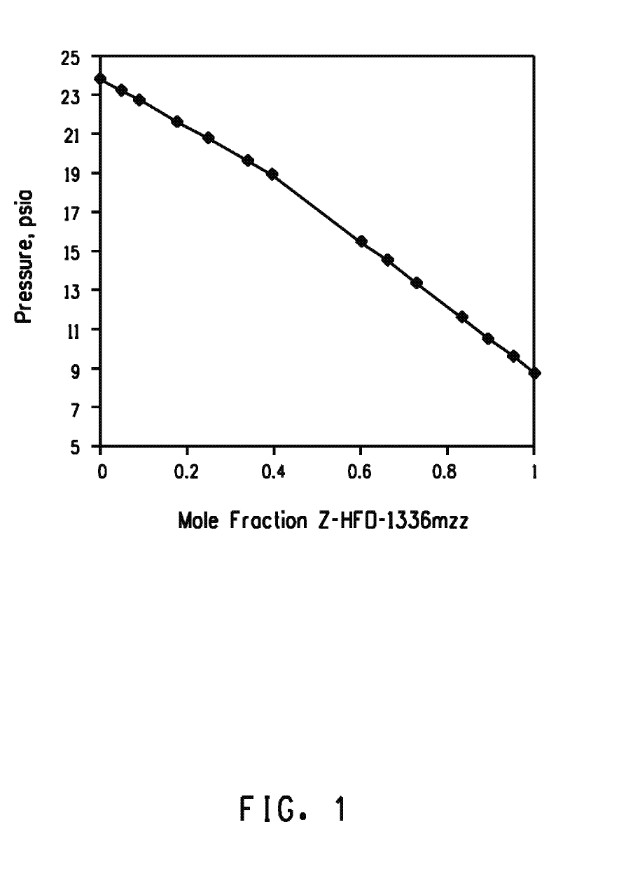

The pressures measured versus the compositions in the PTx cell for Z-HFO-1336mzz/E-HFO-1336mzz mixtures are shown in FIG. 1, which graphically illustrates the formation of azeotrope-like compositions consisting essentially of 1-10 mole % Z-HFO-13360mzz and 99-90 mole % E-HFO-1336mzz at about 20.0° C. and pressures ranging from about 22 to about 24 psia, and also illustrates the formation of azeotrope-like compositions consisting essentially of 96-99 mole % Z-HFO-1336mzz and 4-1 mole % E-HFO-1336mzz at about 20.0° C. and pressures ranging from about 9 to about 10 psia.

According to calculation, azeotrope-like compositions consisting essentially of 1-28 mole % Z-HFO-1336mzz and 99-72 mole % E-HFO-1336mzz are formed at temperatures ranging from about −40° C. to about 120° C. (i.e., over this temperature range, the difference in dew point pressure and bubble point pressure of the composition at a particular temperature is less than or equal to 5 percent (based upon the bubble point pressure)). In addition, azeotrope-like compositions consisting essentially of 85-99 mole % Z-HFO-1336mzz and 15-1 mole % E-HFO-1336mzz are formed at temperatures ranging from about −40° C. to about 120° C. over this temperature range, the difference in dew point pressure and bubble point pressure of the composition at a particular temperature is less than or equal to 5 percent (based upon the bubble point pressure)).

Some embodiments of azeotrope-like compositions are listed in Table 1.

TABLE 1
Azeotrope-like compositions

| COMPONENTS | T (° C.) | Mole Percentage Range |
|---|---|---|
| Z-HFO-1336mzz/E-HFO-1336mzz | −40 | 1-6/99-94 and 98-99/2-1 |
| Z-HFO-1336mzz/E-HFO-1336mzz | −20 | 1-7/99-93 and 97-99/3-1 |
| Z-HFO-1336mzz/E-HFO-1336mzz | 0 | 1-9/99-91 and 97-99/3-1 |
| Z-HFO-1336mzz/E-HFO-1336mzz | 20 | 1-10/99-90 and 96-99/4-1 |
| Z-HFO-1336mzz/E-HFO-1336mzz | 40 | 1-12/99-88 and 95-99/5-1 |
| Z-HFO-1336mzz/E-HFO-1336mzz | 60 | 1-15/99-85 and 94-99/6-1 |
| Z-HFO-1336mzz/E-HFO-1336mzz | 80 | 1-17/99-83 and 92-99/8-1 |
| Z-HFO-1336mzz/E-HFO-1336mzz | 100 | 1-22/99-78 and 90-99/10-1 |
| Z-HFO-1336mzz/E-HFO-1336mzz | 120 | 1-28/99-72 and 85-99/15-1 |

The azeotrope-like compositions of the present invention can be prepared by any convenient method including mixing or combining the desired amounts. In one embodiment of this invention, an azeotrope-like composition can be prepared by weighing the desired component amounts and thereafter combining them in an appropriate container.

### Applications of the Zeotrope-Like Compositions of Z-HFO-1336mzz and E-HFO-1336mzz

The azeotrope-like compositions of the present invention can be used in a wide range of applications, including theft use as aerosol propellants, refrigerants, solvents, cleaning agents, blowing agents (foam expansion agents) for thermoplastic and thermoset foams, heat transfer media, gaseous dielectrics, fire extinguishing and suppression agents, power cycle working fluids, polymerization media, particulate removal fluids, carrier fluids, buffing abrasive agents, and displacement drying agents.

One embodiment of this invention provides a process for preparing a thermoplastic or thermoset foam. The process comprises using an azeotrope-like composition as a blowing agent, wherein said azeotrope-like composition consists essentially of Z-HFO-1336mzz and E-HFO-1336mzz.

Another embodiment of this invention provides a process for producing refrigeration. The process comprises condensing an azeotrope-like composition and thereafter evaporating said azeotrope-like composition in the vicinity of the body to be cooled, wherein said azeotrope-like composition consists essentially of Z-HFO-1336mzz and E-HFO-1336mzz.

Another embodiment of this invention provides a process using an azeotrope-like composition as a solvent, wherein said azeotrope-like composition consists essentially of Z-HFO-1336mzz and E-HFO-1336mzz.

Another embodiment of this invention provides a process for producing an aerosol product. The process comprises using an azeotrope-like composition as a propellant, wherein said azeotrope-like composition consists essentially of Z-HFO-1336mzz and E-HFO-1336mzz.

Another embodiment of this invention provides a process using an azeotrope-like composition as a heat transfer media, wherein said azeotrope-like composition consists essentially of Z-HFO-1336mzz and E-HFO-1336mzz.

Another embodiment of this invention provides a process for extinguishing or suppressing a fire. The process comprises using an azeotrope-like composition as a fire extinguishing or suppression agent, wherein said azeotrope-like composition consists essentially of Z-HFO-1336mzz and E-HFO-1336mzz.

Another embodiment of this invention provides a process using an azeotrope-like composition as dielectrics, wherein said azeotrope-like composition consists essentially of Z-HFO-1336mzz and E-HFO-1336mzz.

### Foam-Forming Compositions Containing the Azeotrope-like Compositions of Z-HFO-1336mzz and E-HFO-1336mzz

This application also includes foam-forming compositions comprising: (a) azeotrope-like composition of Z-HFO-1336mzz and E-HFO-1336mzz as described in this disclosure; and (b) an active hydrogen-containing compound having two or more active hydrogens.

Azeotrope-like compositions of Z-HFO-1336mzz and E-HFO-1336mzz can be used as blowing agents for making polyurethane or polyisocyanurate polymer foams, Typically Z-HFO-1336mzz and E-HFO-1336mzz are combined prior to mixing with the other components in the foam-forming compositions. Alternatively, one can be mixed with some or all of the other components before the other is mixed in. For example, Z-HFO-1336mzz can be first mixed with the other components in the foam-forming compositions before E-HFO-1336mzz is added in.

The active hydrogen-containing compounds of this disclosure can comprise compounds having two or more groups that contain an active hydrogen atom reactive with an isocyanate group, such as described in U.S. Pat. No. 4,394,491. Examples of such compounds have at least two hydroxyl groups per molecule, and more specifically comprise polyols, such as polyether or polyester polyols. Examples of such polyols are those which have an equivalent weight of about 50 to about 700, normally of about 70 to about 300, more typically of about 90 to about 270, and carry at least 2 hydroxyl groups, usually 3 to 8 such groups.

Examples of suitable polyols comprise polyester polyols such as aromatic polyester polyols, e.g., those made by transesterifying polyethylene terephthalate (PET) scrap with a glycol such as diethylene glycol, or made by reacting phthalic anhydride with a glycol. The resulting polyester polyols may be reacted further with ethylene—and/or propylene oxide—to form an extended polyester polyol containing additional internal alkyleneoxy groups.

Examples of suitable polyols also comprise polyether polyols such as polyethylene oxides, polypropylene oxides, mixed polyethylene-propylene oxides with terminal hydroxyl groups, among others. Other suitable polyols can be prepared by reacting ethylene and/or propylene oxide with an initiator having 2 to 16, generally 3 to 8 hydroxyl groups as present, for example, in glycerol, pentaerythritol and carbohydrates such as sorbitol, glucose, sucrose and the like polyhydroxy compounds. Suitable polyether polyols can also include alaphatic or aromatic amine-based polyols.

This application also includes processes for producing a closed-cell polyurethane or polyisocyanurate polymer foam comprising: reacting an effective amount of the foam-forming composition of this disclosure with a suitable polyisocyanate.

Typically, before reacting with a suitable polyisocyanate, the active hydrogen-containing compound described hereinabove and optionally other additives are mixed with the blowing agent to form a foam-forming composition. Such foam-forming composition is typically known in the art as an isocyanate-reactive preblend, or B-side composition. The foam-forming composition of this invention can be prepared in any manner convenient to one skilled in this art, including simply weighing desired quantities of each component and, thereafter, combining them in an appropriate container at appropriate temperatures and pressures.

When preparing polyisocyanate-based foams, the polyisocyanate reactant is normally selected in such proportion relative to that of the active hydrogen-containing compound that the ratio of the equivalents of isocyanate groups to the equivalents of active hydrogen groups, i.e., the foam index, is from about 0.9 to about 10 and in most cases from about 1 to about 4.

While any suitable polyisocyanate can be employed in the instant process, examples of suitable polyisocyanates useful for making polyisocyanate-based foam comprise at least one of aromatic, aliphatic and cycloaliphatic polyisocyanates, among others. Representative members of these compounds comprise diisocyanates such as meta- or paraphenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate (and isomers), napthylene-1,5-diisocyanate, 1-methylphenyl-2,4-phenyldiisocyanate, diphenylmethane-4,4-diisocyanate, diphenylmethane-2,4-diissocyanate, 4,4-biphenyienediisocyanate and 3,3-dimethyoxy-4,4-biphenylenediisocyanate and 3,3-dimethyldiphenylpropane-4,4-diisocyanate; triisocyanates such as toluene-2,4,6-triisocyanate and polyisocyanates such as 4,4-dimethyldiphenylmethane-2,2,5,5-tetraisocyanate and the diverse polymethylenepoly-phenylopolyisocyanates, mixtures thereof, among others.

A crude polyisocyanate may also be used in the practice of this invention, such as the crude toluene diisocyanate obtained by the phosgenating a mixture comprising toluene diamines, or the crude diphenylmethane diisocyanate obtained by the phosgenating crude diphenylmethanediamine. Specific examples of such compounds comprise methylene-bridged polyphenylpolyisocyanates, due to their ability to crosslink the polyurethane.

It is often desirable to employ minor amounts of additives in preparing polyisocyanate-based foams. Among these additives comprise one or more members from the group consisting of catalysts, surfactants, flame retardants, preservatives, colorants, antioxidants, reinforcing agents, filler, antistatic agents, among others well known in this art.

Depending upon the composition, a surfactant can be employed to stabilize the foaming reaction mixture while curing. Such surfactants normally comprise a liquid or solid organosilicone compound. The surfactants are employed in amounts sufficient to stabilize the foaming reaction mixture against collapse and to prevent the formation of large, uneven cells. In one embodiment of this invention, about 0.1% to about 5% by weight of surfactant based on the total weight of all foaming ingredients (i.e. blowing agents+active hydrogen-containing compounds+polyisocyanates+additives) are used. In another embodiment of this invention, about 1.5% to about 3% by weight of surfactant based on the total weight of all foaming ingredients are used.

One or more catalysts for the reaction of the active hydrogen-containing compounds, e.g. polyols, with the polyisocyanate may be also employed. While any suitable urethane catalyst may be employed, specific catalyst comprise tertiary amine compounds and organometallic compounds. Exemplary such catalysts are disclosed, for example, in U.S. Pat. No. 5,164,419, which disclosure is incorporated herein by reference. For example, a catalyst for the trimerization of polyisocyanates, such as an alkali metal alkoxide, alkali metal carboxylate, or quaternary amine compound, may also optionally be employed herein. Such catalysts are used in an amount which measurably increases the rate of reaction of the polyisocyanate. Typical amounts of catalysts are about 0.1% to about 5% by weight based on the total weight of all foaming ingredients.

In the process of making a polyisocyanate-based foam, the active hydrogen-containing compound (e.g. polyol), polyisocyanate and other components are contacted, thoroughly mixed, and permitted to expand and cure into a cellular polymer. The mixing apparatus is not critical, and various conventional types of mixing head and spray apparatus are used. By conventional apparatus is meant apparatus, equipment, and procedures conventionally employed in the preparation of isocyanate-based foams in which conventional isocyanate-based foam blowing agents, such as fluorotrichloromethane (CCl₃F, CFC-11), are employed. Such conventional apparatus are discussed by: H. Boden et al. in chapter 4 of the Polyurethane Handbook, edited by G. Oertel, Hanser Publishers, New York, 1985; a paper by H. Grunbauer et al. titled “Fine Celled CFC-Free Rigid Foam—New Machinery with Low Boiling Blowing Agents” published in Polyurethanes 92 from the Proceedings of the SPI 34th Annual Technical/Marketing Conference, Oct. 21-Oct. 24, 1992, New Orleans, La.; and a paper by M. Taverna et al. titled “Soluble or Insoluble Alternative Blowing Agents? Processing Technologies for Both Alternatives, Presented by the Equipment Manufacturer”, published in Polyurethanes World Congress 1991 from the Proceedings of the SPI/SOPA Sep. 24-26, 1991, Acropolis, Nice, France.

In one embodiment of this invention, a preblend of certain raw materials is prepared prior to reacting the polyisocyanate and active hydrogen-containing components. For example, it is often useful to blend the polyol(s), blowing agent, surfactant(s), catalysts(s) and other foaming ingredients, except for polyisocyanates, and then contact this blend with the polyisocyanate. Alternatively, all the foaming ingredients may be introduced individually to the mixing zone where the polyisocyanate and polyol(s) are contacted. It is also possible to pre-react all or a portion of the polyol(s) with the polyisocyanate to form a prepolymer.

The invention composition and processes are applicable to the production of all kinds of expanded polyurethane foams, including, for example, integral skin, RIM and flexible foams, and in particular rigid closed-cell polymer foams useful in spray insulation, as pour-in-place appliance foams, or as rigid insulating board stock and laminates.

This application also includes closed-cell polyurethane or polyisocyanurate polymer foams prepared from reaction of an effective amount of the foam-forming composition of this disclosure with a suitable polyisocyanate.

### EXAMPLES

The concepts described herein will be further described in the following examples, which do not limit the scope of the invention described in the claims.

VORANOL® 490 is a sucrose/glycerine initiated polyether polyol from Dow Chemical Co.

VORANOL® 391 is a toluene diamine (o-TDA) initiated aromatic polyether polyol from Dow Chemical Co.

STEPANPOL® PS2502A is a polyester polyol from Stepan Co.

NIAX Silicone L-6900 is a surfactant comprising 60-90% siloxane polyalkyleneoxide copolymer and 10-30% polyalkylene oxide available from Momentive Performance Materials.

POLYCAT® 8 is N,N-dimethylcyclohexylamine from Air Products Inc.

POLYCAT® 5 is pentamethyldiethylenetriamine from Air Products Inc.

CURITHANE® 52 is 2-methyl(n-methyl amino b-sodium acetate nonyl phenol) from Air Products Inc.

PAPI 27 is polymethylene polyphenyl isocyanate from Dow Chemical Co.

### Example 1

In Example 1, a polyurethane foam was made using an azeotrope like blowing agent composition of 3 weight % of E-1,1,1,4,4,4-hexafluoro-2-butene and 97 weight % of Z-1,1,1,4,4,4-hexafluoro-2-butene. The foam-forming composition is shown in Table 2. The k-factor and other properties of the resultant foam is shown in Table 3. The foam exhibited good dimensional stability and cell structure, and had a density of 1.7 pcf (pounds-per-cubic-feet).

By “cream time”, it is meant to refer to the time period starting from the mixing of the active hydrogen-containing compound with polyisocyanate, and ending at when the foaming starts to occur and color of the mixture starts to change.

By “rise time”, it is meant to refer to the time period starting from the mixing of the active hydrogen-containing compound with polyisocyanate, and ending at when the foam rising stops.

By “tack free time”, it is meant to refer to the time period starting from the mixing of the active hydrogen-containing compound with polyisocyanate, and ending at when the surface of the foam is no longer tacky.

By “initial k-factor”, it is meant to refer to the polymer foam's thermal conductivity measured at a mean temperature of 75° F. approximately one day after the foam is formed and becomes tack free.

Blowing agents Z-HFO-1336mzz and E-HFO-1336mzz were premixed to form an azeotrope -like mixture containing 3 weight % of E-HFO-1336mzz and 97 weight % of Z-HFO-1336mzz.

Polyols, surfactant, catalysts, water and the above made blowing agent mixture (3 weight % of E-HFO-1336mzz and 97 weight % of Z-HFO-1336mzz) were pre-mixed by hand and then mixed with polyisocyanate. The amount of each component is illustrated in Table 2 as parts-by-weight (pbw) based on the total weight of the polyols. The resulting mixture was poured into a 8″×8″×2.5″ paper box to form the polyurethane foam.

TABLE 2
Polyurethane formulation

| Component | Quantity (pbw) |
|---|---|
| VORANOL ® 490 | 40 |
| VORANOL ® 391 | 35 |
| STEPANPOL ® PS2502A | 25 |
| NIAX Silicone L-6900 | 6.0 |
| POLYCAT ® 8 | 3.0 |
| POLYCAT ® 5 | 0.38 |
| CURITHANE ® 52 | 0.50 |
| Water | 1.7 |
| Blowing Agent Composition | 42.1 |
| Z-1,1,1,4,4,4-hexafluoro-2-butene | 40.79 |
| E-1,1,1,4,4,4-hexafluoro-2-butene | 1.26 |
| PAPI 27 | 148 |
| Foam Index | 1.2 |

TABLE 3
Polyurethane foam properties

| | |
|---|---|
| Cream Time(second) | 9 |
| Rise Time(second) | 65 |
| Tack Free Time (second) | 75 |
| Foam density (pounds-per-cubic-feet) | 1.7 |
| Initial k-factor (Btu · in/ft² · h · ° F.) | 0.136 |

1. An azeotrope-like composition consisting essentially of:
(a) Z-1,1,1,4,4,4-hexafluoro-2-butene; and
(b) E-1,1,1,4,4,4-hexafluoro-2-butene; wherein the E-1,1,1,4,4,4-hexafluoro-2-butene is present in an effective amount to form an azeotrope-like combination with the Z-1,1,1,4,4,4-hexafluoro-2-butene.

2. A process for preparing a thermoplastic or thermoset foam comprising using the azeotrope-like composition of claim 1 as a blowing agent.

3. A process for producing refrigeration comprising condensing the azeotrope-like composition of claim 1 and thereafter evaporating said azeotrope-like composition in the vicinity of the body to be cooled.

4. A process comprising using the azeotrope-like composition of claim 1 as a solvent.

5. A process for producing an aerosol product comprising using the azeotrope-like composition of claim 1 as a propellant.

6. A process comprising using the azeotrope-like composition of claim 1 as a heat transfer media.

7. A process for extinguishing or suppressing a fire comprising using the azeotrope-like composition of claim 1 as a fire extinguishing or suppression agent.

8. A process comprising using the azeotrope-like composition of claim 1 as dielectrics.

9. A foam-forming composition comprising:
(a) the azeotrope-like composition of claim 1; and
(b) an active hydrogen-containing compound having two or more active hydrogens.

10. A process for producing a closed-cell polyurethane or polyisocyanurate polymer foam comprising: reacting an effective amount of the foam-forming composition of claim 9 with a suitable polyisocyanate.

11. A closed-cell polyurethane or polyisocyanurate polymer foam prepared from reaction of an effective amount of the foam-forming composition of claim 9 with a suitable polyisocyanate.
